(19) United States
(12) Patent Application Publication
(10) Pub. No.: US 2025/0306829 A1
(43) Pub. Date: Oct. 2, 2025

(54) PRINTING SYSTEM, PRINTING APPARATUS, AND NON-TRANSITORY COMPUTER-READABLE STORAGE MEDIUM STORING PROGRAM

(71) Applicant: SEIKO EPSON CORPORATION, TOKYO (JP)

(72) Inventors: Ikumi WATANABE, SHIOJIRI-SHI (JP); Yasuo SUNAGA, MATSUMOTO-SHI (JP); Kenya AKIYAMA, SUWA-SHI (JP); Masayuki ISHIDA, Matsumoto-shi (JP); Jun FUKASAWA, MATSUMOTO-SHI (JP)

(21) Appl. No.: 19/094,848

(22) Filed: Mar. 29, 2025

(30) Foreign Application Priority Data
Mar. 29, 2024 (JP) 2024-055680

(51) Int. Cl. G06F 3/12; B41J 3/46; B41J 29/393

(52) U.S. Cl. CPC G06F 3/1293; B41J 3/46; B41J 29/393

(57) ABSTRACT

A printing apparatus receives command information including one or more commands for causing the printing apparatus to execute a specific operation. The printing apparatus performs processing for displaying a permission screen for accepting permission to drive a specific first drive component at least when the command information requests the driving of the first drive component. The printing apparatus executes a command for driving the first drive component in response to acceptance of an operation for the permission on the permission screen.

The present application is based on, and claims priority from JP Application Serial Number 2024-055680, filed Mar. 29, 2024, the disclosure of which is hereby incorporated by reference herein in its entirety.

### BACKGROUND

### 1. Technical Field

The present disclosure relates to a printing system, a printing apparatus, and a non-transitory computer-readable storage medium storing a program.

### 2. Related Art

JP-A-2020-131631 discloses a technique for causing a printing apparatus at a remote location to execute maintenance processing. A server acquires maintenance information including remaining ink amount information indicating an amount of ink remaining in an ink container of the printing apparatus, and determines whether or not the maintenance processing can be executed, based on the acquired maintenance information. When the server determines that the maintenance processing can be executed, the server instructs the execution of the maintenance processing of the printing apparatus.

When an attempt to operate a drive component of the printing apparatus is made from the remote location in the maintenance processing, the following problem occurs for a worker such as a customer or service staff at a site where the printing apparatus is installed. That is, the operation of the drive component may be unexpected for the worker. Therefore, when the maintenance processing of the printing apparatus is executed from the remote location, it is desired that an instruction is performed in consideration of the site where the printing apparatus is installed.

### SUMMARY

According to an aspect of the present disclosure, a printing system includes: a printing apparatus that includes one or more drive components and performs printing; and a terminal apparatus communicably coupled to the printing apparatus via a network. The terminal apparatus includes a command transmission processing section that performs processing for transmitting, to the printing apparatus, command information including one or more commands for causing the printing apparatus to execute a specific operation. The printing apparatus includes a command receiving section that receives the command information, a permission display processing section that performs processing for displaying a permission screen for accepting permission to drive a specific first drive component at least when the command information requests the driving of the first drive component, and a command executing section that executes a command for driving the first drive component in response to acceptance of an operation for the permission on the permission screen.

According to an aspect of the present disclosure, a printing apparatus includes one or more drive components and performs printing. The printing apparatus includes: a command receiving section that receives command information including one or more commands for causing the printing apparatus to execute a specific operation; a permission display processing section that performs processing for displaying a permission screen for accepting permission to drive a specific first drive component at least when the command information requests driving of the first drive component; and a command executing section that executes a command for driving the first drive component in response to acceptance of an operation for the permission on the permission screen.

According to an aspect of the present disclosure, a non-transitory computer-readable storage medium storing a program for causing a computer of a printing apparatus which includes one or more drive components and performs printing to execute processing for receiving command information including one or more commands for causing the printing apparatus to execute a specific operation, processing for displaying a permission screen for accepting permission to drive a specific first drive component at least when the command information requests the driving of the first drive component, and processing for executing a command for driving the first drive component in response to acceptance of an operation for the permission on the permission screen.

### BRIEF DESCRIPTION OF THE DRAWINGS

FIG. 1 is a diagram illustrating a printing system according to a first embodiment.

FIG. 2 is a diagram illustrating a configuration of a terminal apparatus according to the first embodiment.

FIG. 3 is a diagram illustrating a configuration of a printing apparatus according to the first embodiment.

FIG. 4 is a flowchart of processing executed by the terminal apparatus according to the first embodiment.

FIG. 5 is a flowchart of processing executed by the printing apparatus according to the first embodiment.

FIG. 6 is diagram illustrating an example of a permission screen displayed on the printing apparatus according to the first embodiment.

FIG. 7 is a diagram illustrating an example of an instruction screen displayed on the terminal apparatus according to the first embodiment.

FIG. 8 is a diagram illustrating a drive designation screen displayed on the terminal apparatus according to the first embodiment.

FIG. 9 is a diagram illustrating an instruction screen displayed on the terminal apparatus according to the first embodiment.

FIG. 10 is a diagram illustrating an example of a detection designation screen displayed on the terminal apparatus according to the first embodiment.

FIG. 11 is a diagram illustrating an example of a report screen displayed on the printing apparatus according to the first embodiment.

FIG. 12 is a diagram illustrating an example of a question entry screen displayed on the terminal apparatus according to the first embodiment.

FIG. 13 is a diagram illustrating an example of a question screen displayed on the printing apparatus according to the first embodiment.

FIG. 14 is a diagram illustrating command information according to the first embodiment.

### DESCRIPTION OF EMBODIMENTS

### First Embodiment

Hereinafter, an embodiment will be described with reference to the drawings. For clarification of the description, in the following description and drawings, omissions and simplifications are made as appropriate. In the drawings, the same elements are denoted by the same reference signs, and redundant description thereof will be omitted as appropriate.

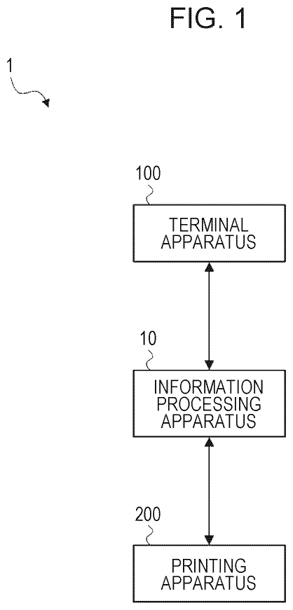

FIG. 1 is a diagram illustrating a printing system 1 according to a first embodiment. The printing system 1 includes an information processing apparatus 10, a terminal apparatus 100, and one or more printing apparatuses 200. The terminal apparatus 100 is communicably coupled to the information processing apparatus 10 via a wired or wireless network. The printing apparatus 200 is communicably coupled to the information processing apparatus 10 via a wired or wireless network.

The information processing apparatus 10 is a computer including a processor, a memory, and the like. The information processing apparatus 10 is, for example, a computer such as a server, and is, for example, a cloud server that communicates with the terminal apparatus 100 and the printing apparatus 200 via the Internet. The terminal apparatus 100 is, for example, a computer such as a personal computer (PC). The configuration of the terminal apparatus 100 will be described later in detail.

The printing apparatus 200 is an apparatus that performs printing, such as a printer. The printing apparatus 200 may have a function as a computer. In addition, the printing apparatus 200 includes one or more drive components. When each of the one or more drive components is driven, the printing apparatus 200 performs a printing process. The drive component is, for example, a physically operating component such as a motor, an actuator, or a solenoid. The drive component includes, for example, a component for transporting a medium such as paper. The drive component includes, for example, a component constituting a carriage. Furthermore, the drive component includes, for example, a component constituting a pump.

The printing apparatus 200 is installed at a site of a customer such as a company or a store. On the other hand, the terminal apparatus 100 is provided at a remote location away from the site. The terminal apparatus 100 is a terminal on a service provider side that provides a service, such as a support service. The support service may be, for example, a service related to maintenance or billing of the printing apparatus 200.

In the printing system 1 according to the first embodiment, the service provider performs maintenance processing on the printing apparatus 200 installed at the site from the remote location by using the terminal apparatus 100. That is, the service provider performs the maintenance processing by remotely controlling the printing apparatus 200 from the remote location by using the terminal apparatus 100. Specifically, command information including a command for causing the printing apparatus 200 to execute a specific operation is generated by operating the terminal apparatus 100 by a user of the terminal apparatus 100. When the command information is transmitted to the printing apparatus 200, the printing apparatus 200 executes the command indicated by the command information and executes the specific operation instructed by the command. Hereinafter, a user who performs remote control of the printing apparatus 200 by using the terminal apparatus 100 is referred to as an instructor who instructs the remote control. The instructor is, for example, an engineer of the printing apparatus 200, but is not limited thereto. The command information will be described later in detail. In the maintenance processing, the service provider dispatches service staff to the site of the customer, or instructs the customer at the site to perform work. Hereinafter, the service staff at the site or the customer at the site who works in the vicinity of the printing apparatus 200 is referred to as a worker.

The information processing apparatus 10 may be a server that manages the printing apparatus 200. Furthermore, the information processing apparatus 10 may be a server that stores various kinds of information. Furthermore, the information processing apparatus 10 may be a server that relays transmission and reception of various kinds of information between the terminal apparatus 100 and the printing apparatus 200. Therefore, the terminal apparatus 100 is communicably coupled to the printing apparatus 200 via a network.

The printing system 1 may include a plurality of printing apparatuses 200. In this case, the information processing apparatus 10 may manage the plurality of printing apparatuses 200. In this case, the instructor may perform maintenance processing on the plurality of printing apparatuses 200 by remote control by using the terminal apparatus 100.

The information processing apparatus 10 collects and stores apparatus information that is information regarding the printing apparatus 200. The apparatus information may include, for example, log information in which a history or the like regarding the printing apparatus 200 is recorded. Furthermore, the apparatus information may include state information indicating a state of the printing apparatus 200. The state information may include a detection value detected by a detecting component such as a sensor or an encoder of the printing apparatus 200. In addition, as will be described later, the apparatus information may include information obtained by the printing apparatus 200 executing the command information. The information processing apparatus 10 transmits the stored apparatus information to the terminal apparatus 100. The information processing apparatus 10 may store the command information to be transmitted to the printing apparatus 200. Since the information processing apparatus 10 stores the apparatus information and the command information, a record of communication between the terminal apparatus 100 and the printing apparatus 200 can be stored. Therefore, it is possible to easily check the content of the communication.

In addition, the information processing apparatus 10 may have a function as a web server that provides, to the terminal apparatus 100, a remote control web service for performing remote control. In this case, the information processing apparatus 10 includes a web application that provides the remote control web service. The terminal apparatus 100 may access the remote control web service by using a web browser, and the instructor may operate the terminal apparatus 100 to generate the command information by using the remote control web service. In this case, the command information may be generated by the information processing apparatus 10. Furthermore, when the instructor operates the terminal apparatus 100 to give an instruction to transmit the command information by using the remote control web service, the information processing apparatus 10 transmits the generated command information to the printing apparatus 200. Then, the printing apparatus 200 receives the command information. That is, the terminal apparatus 100 performs processing for transmitting the command information to the printing apparatus 200.

Alternatively, the command information may be generated by the terminal apparatus 100. In this case, the terminal apparatus 100 may have substantially the same function as that of the above-described web application that provides the remote control web service. The terminal apparatus 100 generates the command information when the instructor operates the terminal apparatus 100. The terminal apparatus 100 transmits the command information to the information processing apparatus 10. The information processing apparatus 10 transmits the command information to the printing apparatus 200. The printing apparatus 200 receives the command information. That is, the information processing apparatus 10 relays the command information transmitted from the terminal apparatus 100 toward the printing apparatus 200. That is, even in this case, the terminal apparatus 100 may perform processing for transmitting the command information to the printing apparatus 200.

Since the command included in the command information causes the printing apparatus 200 to execute the specific operation by remote control, the command may be referred to as a remote control command. In addition, the remote control command may cause the printing apparatus 200 to execute the special operation which is not executed in a normal printing process. Therefore, the remote control command may also be referred to as a special command. The special command may cause the printing apparatus 200 to execute an operation different from an operation stored in advance in the printing apparatus 200 for performing a normal printing process. In other words, the special command may cause the printing apparatus 200 to execute an operation different from an operation executed in the normal printing process. That is, the special command is a command that can be used by the instructor, and cannot be used by the worker such as the service staff at the site or the customer at the site. The “normal printing process” may be, for example, a printing process which is performed in a state in which any failure does not occur in the printing apparatus 200. In addition, the “operation executed in the normal printing process” may be, for example, an operation that can be executed by an operation on an operation panel of the printing apparatus 200 or a terminal apparatus of the worker. The terminal apparatus of the worker is a terminal apparatus not illustrated in FIG. 1, and is a terminal apparatus used when the customer transmits a print job to the printing apparatus 200 and causes the printing apparatus 200 to execute the print job, or a terminal apparatus used by the service staff for maintenance. Furthermore, the “operation executed in the normal printing process” may be, for example, an operation that can be executed by actually touching and operating the printing apparatus 200 by the worker at the site who is present near the printing apparatus 200. For example, the “operation executed in the normal printing process” includes normal paper feeding, normal printing, normal ink circulation processing, and the like.

In the printing system 1 according to the first embodiment, when the command information requests driving of a specific first drive component, the printing apparatus 200 displays a permission screen for accepting permission to drive the first drive component. The permission screen is displayed on a display section such as the operation panel of the printing apparatus 200. The permission screen is implemented by, for example, a graphical user interface (GUI) in the printing apparatus 200. The permission screen includes, for example, a message indicating content for which permission is requested, and a button on which an operation for the permission is performed. The worker at the site can permit the driving of the first drive component by operating the permission screen. As described above, the printing apparatus 200 executes a command for driving the first drive component in response to acceptance of the operation for the permission on the permission screen. Thus, the first drive component is driven.

When the maintenance processing of the printing apparatus 200 is performed by remote control from the remote location, there is a possibility that the instructor at the remote location does not know the situation of the site. When the instructor instructs driving of a drive component of the printing apparatus 200 in such a state, there is a possibility that the drive component is driven in a situation which is not expected by the worker at the site. In addition, the worker may not be able to use a communication device such as a mobile phone or a smartphone in the site. In such a case, it is also difficult to perform communication between the instructor and the worker using a mobile terminal. Therefore, it is also difficult for the instructor to notify the worker in advance that remote control for driving the drive component is to be performed.

On the other hand, in the first embodiment, with the above-described configuration, it is possible to accept the permission of the worker at the site before the first drive component is driven by the remote control. Therefore, when the maintenance processing of the printing apparatus 200 is performed from the remote location, the instructor at the remote location can give an instruction in consideration of the site. As a result, it is possible to give a sense of security to the worker at the site.

The command information will be described. The command included in the command information is designated by the instructor by using the terminal apparatus 100. The instructor is the user of the terminal apparatus 100. In other words, the command included in the command information is designated by the instructor operating the terminal apparatus 100. For example, the command included in the command information is designated by an operation on an instruction screen displayed on the terminal apparatus 100.

The instruction screen is a screen for accepting a user's instruction, that is, an instructor's instruction for generating the command information. Specifically, the instruction screen is a screen for designating an element to be designated by the instructor in the command information. The instruction screen is implemented by, for example, a GUI in the terminal apparatus 100. The instruction screen may include GUI elements such as an icon, a menu, a window, a button, a check box, a radio button, a text box, a text area, and a scroll bar.

The command information may include, for example, a drive command and an information processing command. Note that the information processing command may include a plurality of types of commands as will be described later. The instructor may designate, on a command designation screen displayed on the terminal apparatus 100, a command to be transmitted to the printing apparatus 200 and to be executed by the printing apparatus 200. The command designation screen is implemented by, for example, a GUI in the terminal apparatus 100. The command designation screen is a screen for accepting designation of a command to be transmitted to the printing apparatus 200 and to be executed by the printing apparatus 200. An example of the command designation screen will be described later.

The drive command is a command for requesting driving of the specific first drive component to be driven in the printing apparatus 200. When the printing apparatus 200 executes the drive command, the first drive component designated by the drive command is driven. The drive command designates the first drive component to be driven, and designates a drive amount of the first drive component. The drive amount includes a drive direction of the first drive component. For example, when the first drive component is a motor, the drive amount includes a rotation direction and a rotation amount. The instructor may designate the first drive component and the drive amount in the drive command by performing an operation on a drive designation screen which is an instruction screen displayed on the terminal apparatus 100. The drive designation screen is implemented by, for example, a GUI in the terminal apparatus 100. The drive designation screen is a screen for accepting designation of the first drive component to be driven among a plurality of drive components of the printing apparatus 200. The drive designation screen is a screen for accepting designation of the drive amount of the designated first drive component. An example of the drive designation screen will be described later.

The information processing command is a command for requesting some information processing in the printing apparatus 200. Note that the information processing command does not request the driving of the drive components. When the printing apparatus 200 executes the information processing command, information processing designated by the information processing command is executed. Furthermore, the printing apparatus 200 transmits, as apparatus information, information obtained by the executed information processing to the information processing apparatus 10. The information processing command may include, for example, a log transmission command, an operation result transmission command, a detection command, a report command, and a question command. The information processing command may include a permission screen display command for requesting display of the permission screen described above.

The log transmission command is a command for requesting transmission of the log information. When the printing apparatus 200 executes the log transmission command, the log information is transmitted as the apparatus information from the printing apparatus 200 to the information processing apparatus 10. The log information transmitted to the information processing apparatus 10 is transmitted as the apparatus information to the terminal apparatus 100.

The operation result transmission command is a command for requesting information processing for transmitting an operation result of the first drive component. When the printing apparatus 200 executes the operation result transmission command, the operation result of the first drive component is transmitted as the apparatus information from the printing apparatus 200 to the information processing apparatus 10. The operation result transmitted to the information processing apparatus 10 is transmitted as the apparatus information to the terminal apparatus 100.

The detection command is a command for requesting detection by a first detecting component of the printing apparatus 200. When the printing apparatus 200 executes the detection command, the detection by the first detecting component designated by the detection command is executed. Then, a detection value that is a detection result is transmitted as the apparatus information from the printing apparatus 200 to the information processing apparatus 10. The detection result transmitted to the information processing apparatus 10 is transmitted as the apparatus information to the terminal apparatus 100. The detection command designates the first detecting component to be caused to perform detection. The instructor may designate the first detecting component in the detection command by performing an operation on a detection designation screen which is an instruction screen displayed on the terminal apparatus 100. The detection designation screen is implemented by, for example, a GUI in the terminal apparatus 100. The detection designation screen is a screen for accepting designation of the first detecting component to be caused to execute detection among a plurality of detecting components. An example of the detection designation screen will be described later.

The report command is a command for requesting processing for transmitting a report of the operation state of the printing apparatus 200 by the worker at the site. Specifically, the report command is a command for requesting display of a report screen for accepting an operation for reporting the operation state of the printing apparatus 200, and requesting transmission of the report. When the printing apparatus 200 executes the report command, the report screen is displayed on a display section such as the operation panel of the printing apparatus 200. When the worker performs an operation for reporting on the report screen, a report corresponding to the operation is transmitted as the apparatus information from the printing apparatus 200 to the information processing apparatus 10. The report transmitted to the information processing apparatus 10 is transmitted as the apparatus information to the terminal apparatus 100. The report screen is implemented by, for example, a GUI in the printing apparatus 200. The report screen is a screen for accepting an operation for reporting the operation state of the printing apparatus 200. An example of the report screen will be described later.

The question command is a command for requesting processing for the worker to answer a question from the instructor. Specifically, the question command is a command for displaying a question screen for accepting an answer to a question from the instructor, and requesting transmission of the answer to the question. The question screen may display the question from the instructor. When the printing apparatus 200 executes the question command, the question screen is displayed on a display section such as the operation panel of the printing apparatus 200. Furthermore, when an operation for entering an answer to the question is performed on the question screen by the worker, the answer corresponding to the operation is transmitted as the apparatus information from the printing apparatus 200 to the information processing apparatus 10. The answer transmitted to the information processing apparatus 10 is transmitted as the apparatus information to the terminal apparatus 100. The question screen is implemented by, for example, a GUI in the printing apparatus 200. The question screen is a screen for accepting an answer of the worker to a question from the instructor who is the user of the terminal apparatus 100. An example of the question screen will be described later.

The content of the question is entered by the instructor operating the terminal apparatus 100. The instructor may enter the content of the question in the question command by performing an operation on a question entry screen which is an instruction screen displayed on the terminal apparatus 100. The question entry screen is implemented by, for example, a GUI in the terminal apparatus 100. The question entry screen is a screen for accepting the content of an instructor's question to the worker. An example of the question entry screen will be described later.

The permission screen display command is a command for requesting display of the permission screen described above. When the printing apparatus 200 executes the permission screen display command, the permission screen is displayed on the display section of the printing apparatus 200. The permission screen display command includes an instruction to display a message to be displayed on the permission screen and a button on which an operation for permission is performed. Furthermore, when the worker performs an operation for permission on the permission screen, permission information indicating that the permission has been accepted may be transmitted as the apparatus information from the printing apparatus 200 to the information processing apparatus 10. The permission information transmitted to the information processing apparatus 10 may be transmitted as the apparatus information to the terminal apparatus 100.

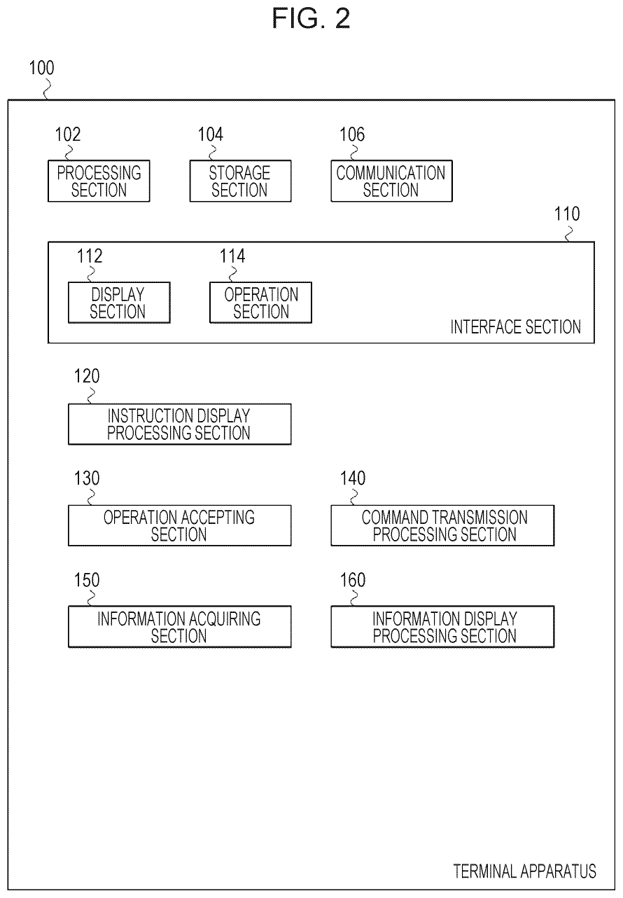

FIG. 2 is a diagram illustrating a configuration of the terminal apparatus 100 according to the first embodiment. The terminal apparatus 100 according to the first embodiment includes a processing section 102, a storage section 104, a communication section 106, and an interface section 110 as a main hardware configuration. The processing section 102, the storage section 104, the communication section 106, and the interface section 110 may be coupled to each other via a data bus or the like.

The processing section 102 is, for example, a processor such as a central processing unit (CPU). The processing section 102 may include a plurality of processors. The processing section 102 has a function as an arithmetic device that performs control processing, arithmetic processing, and the like. The processing section 102 controls the storage section 104, the communication section 106, and the interface section 110.

The storage section 104 is, for example, a storage device such as a memory or a hard disk. The storage section 104 is, for example, a read-only memory (ROM), a random-access memory (RAM), or the like. The storage section 104 may include a plurality of memories. The storage section 104 has a function of storing a control program, an arithmetic program, and the like which are executed by the processing section 102. The storage section 104 has a function of temporarily storing processing data and the like. The storage section 104 may include a database.

The communication section 106 performs processing necessary for the terminal apparatus 100 to communicate with another apparatus via a network. The communication section 106 may include a communication port, a router, a firewall, and the like. The communication section 106 performs processing for the terminal apparatus 100 to communicate with the information processing apparatus 10. The communication section 106 may perform processing for the terminal apparatus 100 to communicate with the printing apparatus 200.

The interface section 110 is, for example, a user interface. The interface section 110 accepts an operation of entering data by the user of the terminal apparatus 100 and outputs information to the user. The interface section 110 includes a display section 112 and an operation section 114. The display section 112 is a display device that displays an image, such as a display. The operation section 114 is an input device, such as a keyboard or a mouse, for inputting or selecting information. The interface section 110 may be configured such that an input device and an output device are integrated, for example, like a touch screen or a touch panel. In this case, the display section 112 and the operation section 114 may be physically integrated. Furthermore, the interface section 110 may include a speaker and a microphone.

The terminal apparatus 100 according to the first embodiment includes, as components, an instruction display processing section 120, an operation accepting section 130, a command transmission processing section 140, an information acquiring section 150, and an information display processing section 160. These components may be operated by an operating system, which is basic software.

Each of the above-described components can be implemented by, for example, executing a program under control by the processing section 102. More specifically, each of the components can be implemented by the processing section 102 executing the program stored in the storage section 104. In addition, each of the components may be implemented by recording a necessary program in any non-volatile recording medium and installing the program as necessary.

In addition, each of the components is not limited to be implemented by software by the program, and may be implemented by any combination of hardware, firmware, and software. In addition, each of the components may be implemented by using an integrated circuit which can be programmed by a user, such as a field-programmable gate array (FPGA) or a microcomputer. In this case, a program including the above-described components may be implemented by using the integrated circuit.

The instruction display processing section 120 performs processing for causing the display section 112 to display the above-described instruction screen. Specifically, the instruction display processing section 120 controls the display section 112 to cause the display section 112 to display the instruction screen. Thus, the instruction screen is displayed on the display section 112. Specifically, the instruction display processing section 120 causes the display section 112 to display, as the instruction screen, the command designation screen, the drive designation screen, the detection designation screen, or the question entry screen as described above.

When the remote control web service is provided by the information processing apparatus 10, the instruction display processing section 120 may cause the display section 112 to display the instruction screen by a function of the web browser. When the information processing apparatus 10 does not provide the remote control web service and the command information is generated by the terminal apparatus 100, the instruction display processing section 120 may generate the instruction screen and cause the display section 112 to display the instruction screen.

The operation accepting section 130 accepts an operation on the instruction screen displayed on the display section 112 by the instruction display processing section 120. Specifically, when the instructor performs an operation on the instruction screen through the GUI, the operation accepting section 130 accepts designation of information regarding a command which corresponds to the operation and is to be transmitted to the printing apparatus 200. The operation accepted by the operation accepting section 130, that is, information regarding the command designated by the instructor is output to the command transmission processing section 140.

For example, the operation accepting section 130 accepts designation of a command to be transmitted to the printing apparatus 200 as an operation on the above-described command designation screen. The command information may include a plurality of commands. In this case, the operation accepting section 130 accepts designation of a plurality of commands to be transmitted to the printing apparatus 200 as an operation on the command designation screen. Furthermore, in this case, the operation accepting section 130 may accept designation of the order in which the plurality of commands are executed as an operation on the command designation screen.

In addition, the operation accepting section 130 accepts designation of a first drive component to be driven among the plurality of drive components and designation of a drive amount of the designated first drive component as an operation on the above-described drive designation screen. Furthermore, the operation accepting section 130 accepts designation of the first detecting component to be caused to execute detection among the plurality of detecting components as an operation on the above-described detection designation screen. In addition, the operation accepting section 130 accepts the content of an instructor's question to the worker as an operation on the question entry screen described above.

The command transmission processing section 140 performs processing for transmitting the command information to the printing apparatus 200. The command transmission processing section 140 controls the communication section 106 to perform processing for transmitting the command information to the printing apparatus 200. Specifically, when the remote control web service is provided by the information processing apparatus 10, the command transmission processing section 140 transmits an operation accepted by the operation accepting section 130 to the information processing apparatus 10. Thus, the information processing apparatus 10 generates command information including one or more commands corresponding to the operation accepted by the operation accepting section 130.

Specifically, the information processing apparatus 10 generates the command information including the one or more commands which have been designated by an operation on the command designation screen and are to be executed by the printing apparatus 200. When the drive command is designated, the information processing apparatus 10 generates command information including the drive command designated by the operation on the drive designation screen and designating the first drive component to be driven and the drive amount. When the detection command is designated, the information processing apparatus 10 generates command information including the detection command designated by the operation on the detection designation screen and designating the first detecting component to be caused to perform the detection. When the question command is designated, the information processing apparatus 10 generates command information including the question command indicating the content of the question entered by the operation on the question entry screen. When a plurality of commands are designated, the information processing apparatus 10 generates command information including the plurality of commands.

Then, the command transmission processing section 140 performs processing such that command information generated in the information processing apparatus 10 is transmitted to the printing apparatus 200. For example, the command transmission processing section 140 may transmit an instruction to the information processing apparatus 10 so as to cause the information processing apparatus 10 to transmit the generated command information to the printing apparatus 200.

More specifically, the command transmission processing section 140 performs processing for transmitting, to the printing apparatus 200, the command information including a command designated by an operation using the instruction screen. The command transmission processing section 140 performs processing for transmitting, to the printing apparatus 200, the command information including the drive command for requesting the driving of the first drive component designated using the drive designation screen. The command transmission processing section 140 performs processing for transmitting, to the printing apparatus 200, the command information including the detection command for requesting the detection by the first detecting component designated using the detection designation screen. Furthermore, the command transmission processing section 140 performs processing for transmitting, to the printing apparatus 200, the command information including the question command for requesting an answer to the question entered on the question entry screen.

In addition, when command information is to be generated by the terminal apparatus 100, the command transmission processing section 140 may generate the command information by substantially the same processing as the processing for generating command information by the information processing apparatus 10 described above. In this case, the command transmission processing section 140 generates the command information including one or more commands corresponding to content designated by an operation on the instruction screen. Then, the command transmission processing section 140 transmits the generated command information to the information processing apparatus 10. Then, the command transmission processing section 140 performs processing such that the command information transmitted to the information processing apparatus 10 is transmitted to the printing apparatus 200. For example, the command transmission processing section 140 may transmit an instruction to the information processing apparatus 10 so as to cause the information processing apparatus 10 to transmit the transmitted command information to the printing apparatus 200. Alternatively, the command transmission processing section 140 may directly transmit the command information to the printing apparatus 200 such that the command information does not pass through the information processing apparatus 10.

The information acquiring section 150 acquires the apparatus information regarding the printing apparatus 200. The information acquiring section 150 may receive the apparatus information stored in the information processing apparatus 10 from the information processing apparatus 10. Alternatively, the information acquiring section 150 may directly receive the apparatus information from the printing apparatus 200. Specifically, the information acquiring section 150 may acquire the log information. In addition, the information acquiring section 150 may acquire an operation result of the first drive component. In addition, the information acquiring section 150 may acquire a detection value of the first detecting component obtained by executing the detection command. Furthermore, the information acquiring section 150 may acquire the report obtained by executing the report command. Furthermore, the information acquiring section 150 may acquire the answer to the question obtained by executing the question command.

Furthermore, the information acquiring section 150 may acquire permission information obtained by an operation on the permission screen. In this case, the command transmission processing section 140 may transmit the drive command for requesting the driving of the first drive component permitted to be driven in the permission information.

The information display processing section 160 performs processing for displaying the apparatus information acquired by the information acquiring section 150. Specifically, the information display processing section 160 controls the display section 112 to cause the display section 112 to display the apparatus information acquired by the information acquiring section 150. Thus, the apparatus information is displayed on the display section 112.

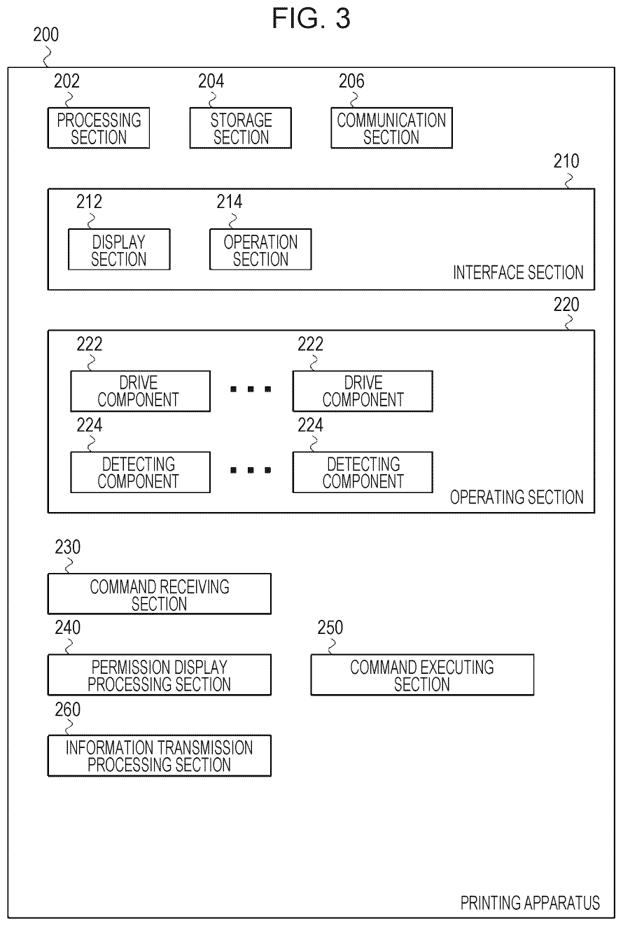

FIG. 3 is a diagram illustrating a configuration of the printing apparatus 200 according to the first embodiment. The printing apparatus 200 includes a processing section 202, a storage section 204, a communication section 206, an interface section 210, and an operating section 220 as a main hardware configuration. The processing section 202, the storage section 204, the communication section 206, the interface section 210, and the operating section 220 may be coupled to each other via a data bus or the like.

The processing section 202 is, for example, a processor such as a CPU. The processing section 202 may include a plurality of processors. The processing section 202 has a function as an arithmetic device that performs control processing, arithmetic processing, and the like. The processing section 202 controls the storage section 204, the communication section 206, the interface section 210, and the operating section 220.

The storage section 204 is, for example, a storage device such as a memory or a hard disk. The storage section 204 is, for example, a ROM or a RAM. The storage section 204 has a function of storing a control program, an arithmetic program, and the like which are executed by the processing section 202. The storage section 204 has a function of temporarily storing processing data and the like. The storage section 204 may include a database.

The communication section 206 performs processing necessary for the printing apparatus 200 to communicate with another apparatus via a network. The communication section 206 may include a communication port, a router, a firewall, and the like. The communication section 206 performs processing for the printing apparatus 200 to communicate with the information processing apparatus 10. The communication section 206 may perform processing for the printing apparatus 200 to communicate with the terminal apparatus 100.

The interface section 210 is, for example, a user interface. The interface section 210 accepts an operation of entering data by a user of the printing apparatus 200 and outputs information to the user. The interface section 210 includes a display section 212 and an operation section 214. The display section 212 is a display device that displays an image, such as a display. The operation section 214 is an input device for inputting or selecting information. The interface section 210 may be configured such that an input device and an output device are integrated, for example, like a touch screen or a touch panel. In this case, the display section 212 and the operation section 214 may be physically integrated. The interface section 210 includes the operation panel. The display section 212 and the operation section 214 constitute the operation panel.

The operating section 220 is an operating mechanism that implements a function of the printing apparatus 200. When the printing apparatus 200 is a printer, the operating section 220 functions as a printing section. In this case, the operating section 220 has a printing function for forming an image on a sheet, that is, a printing medium. In this case, the operating section 220 includes a print engine. The print engine is a mechanical component that executes printing of an image on a printing medium. The print engine may include, for example, a mechanism that performs printing with toner by an electrophotographic method. Alternatively, the print engine may include, for example, a mechanism that performs printing by an ink jet method. In addition, the print engine may include a transport mechanism that transports the printing medium.

The operating section 220 includes one or more drive components 222 and one or more detecting components 224. Each of the one or more drive components 222 is a component that is physically driven in the printing apparatus 200. The physical driving means, for example, that the position of some structure constituting the drive component 222 is changed. As described above, the drive component 222 is, for example, a motor, an actuator, a solenoid, or the like. Each of the one or more drive components 222 includes, for example, a component for transporting a medium such as paper. For example, the drive component 222 may include a paper feeding motor. The drive component 222 includes, for example, a component constituting the carriage. For example, the drive component 222 may include a carriage motor and a carriage lock mechanism. The drive component 222 includes, for example, a component constituting the pump.

Each of the one or more detecting components 224 is a component that detects the state of the printing apparatus 200. As described above, the detecting component 224 is a sensor, an encoder, or the like. For example, the detecting component 224 detects the state of the drive component 222. For example, the detecting component 224 may detect the rotation speed of the drive component 222 which is a motor. Furthermore, for example, the detecting component 224 may detect an amount of ink. Furthermore, for example, the detecting component 224 may detect the temperature of a specific portion of the printing apparatus 200. Furthermore, for example, the detecting component 224 may detect opening/closing states of various covers of the printing apparatus 200.

The printing apparatus 200 according to the first embodiment includes, as components, a command receiving section 230, a permission display processing section 240, a command executing section 250, and an information transmission processing section 260. Note that each of the above-described components can be implemented by, for example, executing a program under control by the processing section 202. More specifically, each of the components can be implemented by the processing section 202 executing the program stored in the storage section 204. In addition, each of the components may be implemented by recording a necessary program in any non-volatile recording medium and installing the program as necessary.

In addition, each of the components is not limited to be implemented by software by the program, and may be implemented by any combination of hardware, firmware, and software. In addition, each of the components may be implemented by using an integrated circuit which can be programmed by a user, such as an FPGA or a microcomputer. In this case, a program including the above-described components may be implemented by using the integrated circuit.

The command receiving section 230 receives command information. The command receiving section 230 receives the command information by using the communication section 206. The command receiving section 230 may receive command information generated by processing performed by the terminal apparatus 100 from the information processing apparatus 10. Alternatively, the command receiving section 230 may directly receive the command information generated by the terminal apparatus 100 from the terminal apparatus 100 such that the command information does not pass through the information processing apparatus 10.

When the command information requests the driving of the first drive component, the permission display processing section 240 performs processing for displaying a permission screen for accepting permission to drive the first drive component. Specifically, when the command information includes a drive command, the permission display processing section 240 performs processing for controlling the display section 212 to cause the display section 212 such as the operation panel to display the permission screen. Thus, the permission screen is displayed on the display section 212. The permission display processing section 240 displays the permission screen when the drive command is to be executed, and does not display the permission screen when the information processing command is to be executed. Furthermore, the permission display processing section 240 accepts an operation for the permission on the permission screen.

The command executing section 250 executes a command included in command information. When the command information includes the drive command, the command executing section 250 executes the drive command for driving the first drive component in response to acceptance of an operation for the permission on the permission screen. When the command information includes the permission screen display command, the command executing section 250 may execute the permission screen display command and cause the permission display processing section 240 to perform processing for displaying the permission screen. It should be noted that when the drive command is included in the command information, the permission display processing section 240 performs processing for displaying the permission screen regardless of whether or not the permission screen display command is included in the command information.

The command executing section 250 executes the drive command and controls the first drive component designated by the drive command such that the first drive component is driven by the drive amount designated by the drive command. In this way, when the driving of the first drive component is permitted by the worker, the first drive component can be driven in accordance with an instruction of the instructor.

The command executing section 250 executes an information processing command and performs predetermined information processing. The command executing section 250 controls the communication section 206 to perform processing for transmitting information obtained by the information processing. The command executing section 250 may perform processing for transmitting, as the apparatus information regarding the printing apparatus 200, the information obtained by the information processing to the terminal apparatus 100. For example, the command executing section 250 may transmit the apparatus information to the information processing apparatus 10 by the communication section 206. Then, the command executing section 250 may transmit an instruction to the information processing apparatus 10 so as to cause the information processing apparatus 10 to transmit the transmitted apparatus information to the terminal apparatus 100. Accordingly, the information processing apparatus 10 transmits the apparatus information transmitted from the printing apparatus 200 to the terminal apparatus 100. In this way, the command executing section 250 performs processing such that the apparatus information is transmitted to the terminal apparatus 100 via the information processing apparatus 10. Alternatively, the command executing section 250 may directly transmit the apparatus information to the terminal apparatus 100 by the communication section 206 such that the apparatus information does not pass through the information processing apparatus 10.

The command executing section 250 executes the log transmission command and performs processing for collecting the log information and transmitting the collected log information. Specifically, the command executing section 250 executes the log transmission command and collects the log information. Then, the command executing section 250 performs processing for transmitting the collected log information as apparatus information to the terminal apparatus 100.

In addition, the command executing section 250 executes the operation result transmission command and performs processing for acquiring an operation result of the first drive component and transmitting the acquired operation result. Specifically, the command executing section 250 executes the operation result transmission command and acquires the operation result of the first drive component. Then, the command executing section 250 performs processing for transmitting the acquired operation result as the apparatus information to the terminal apparatus 100.

In addition, the command executing section 250 executes the detection command and controls the first detecting component such that the first detecting component designated by the detection command performs detection. Then, the command executing section 250 performs processing for transmitting a detection value which is a detection result obtained by the detection by the first detecting component. At this time, the command executing section 250 may perform processing for transmitting the detection value as the apparatus information to the terminal apparatus 100.

In addition, the command executing section 250 executes the report command, performs processing for displaying the report screen, and performs processing for transmitting a report corresponding to an operation on the report screen. More specifically, the command executing section 250 controls the display section 212 such that the report screen is displayed on the display section 212. The command executing section 250 accepts an operation performed on the report screen by the worker. This operation is an operation for reporting. Then, the command executing section 250 performs processing for transmitting, to the terminal apparatus 100, as the apparatus information, the report corresponding to the operation on the report screen.

In addition, the command executing section 250 executes the question command, performs processing for displaying the question screen, and performs processing for transmitting an answer corresponding to an operation on the question screen. Specifically, the command executing section 250 controls the display section 212 such that the question screen is displayed on the display section 212. In addition, the command executing section 250 accepts an operation performed on the question screen by the worker. This operation is an operation for answering a question. Then, the command executing section 250 performs processing for transmitting, to the terminal apparatus 100, as the apparatus information, an answer corresponding to the operation on the question screen.

The command executing section 250 executes the permission screen display command. As a result, the permission display processing section 240 performs processing for displaying the permission screen. When an operation for permission on the permission screen is accepted, the command executing section 250 performs processing for transmitting, to the terminal apparatus 100, as apparatus information, permission information indicating that the operation for the permission has been accepted. After the drive command is received, the command executing section 250 may execute the drive command as described above.

When a plurality of commands are included in the command information and the order in which the plurality of commands are executed is designated in the command information, the command executing section 250 executes each of the plurality of commands in the designated order. When an information processing command after the drive command in the order is present, the command executing section 250 may execute the information processing command after executing the drive command in response to the acceptance of the operation for the permission on the permission screen.

The information transmission processing section 260 autonomously transmits the log information. That is, the information transmission processing section 260 periodically transmits the log information without depending on the execution of a command. The information transmission processing section 260 controls the communication section 206 and transmits the log information to the information processing apparatus 10. The log information transmitted to the information processing apparatus 10 is transmitted to the terminal apparatus 100. Instead of the command executing section 250, the information transmission processing section 260 may perform processing for transmitting the apparatus information acquired in accordance with the execution of the command described above.

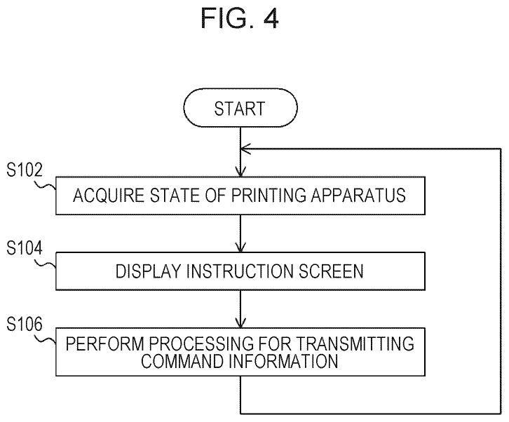

FIG. 4 is a flowchart of processing executed by the terminal apparatus 100 according to the first embodiment. FIG. 4 illustrates an instruction method executed by the terminal apparatus 100. The processing illustrated in FIG. 4 can be implemented by a computer of the terminal apparatus 100 executing a program. In other words, the program causes the computer of the terminal apparatus 100 to execute the processing illustrated in FIG. 4.

The terminal apparatus 100 acquires the state of the printing apparatus 200 (step S102). Specifically, the information acquiring section 150 acquires the apparatus information indicating the state of the printing apparatus 200. The information acquiring section 150 may acquire the apparatus information stored in the information processing apparatus 10. Alternatively, the information acquiring section 150 may directly acquire the apparatus information from the printing apparatus 200.

The terminal apparatus 100 displays the instruction screen (step S104). Specifically, as described above, the instruction display processing section 120 performs processing for displaying the instruction screen on the display section 112. Thus, the display section 112 displays the instruction screen. The instructor checks the apparatus information acquired in S102 and determines the content of remote control to be performed on the printing apparatus 200. Then, the instructor designates a command to be transmitted to the printing apparatus 200 by performing an operation on the instruction screen.

The terminal apparatus 100 performs processing for transmitting command information (step S106). Specifically, as described above, the command transmission processing section 140 performs processing for transmitting, to the printing apparatus 200, the command information including the command designated by the operation using the instruction screen. Accordingly, the command information is transmitted to the printing apparatus 200.

Then, the terminal apparatus 100 acquires the apparatus information such as the operation result generated in response to the execution of the command included in the command information by the printing apparatus 200 (S102). The instructor can check the state of the printing apparatus 200 by checking the apparatus information such as the operation result acquired in S102. Then, the instructor can determine the content of the remote control on the printing apparatus 200 in accordance with the content of the apparatus information acquired in S102. In this way, the processing from S102 to S106 is repeated. In this way, the instructor performs the remote control on the printing apparatus 200.

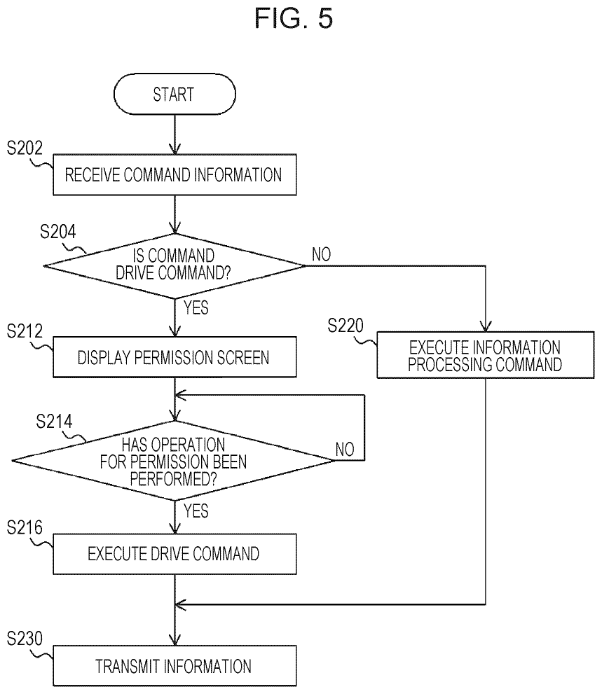

FIG. 5 is a flowchart of processing executed by the printing apparatus 200 according to the first embodiment. FIG. 5 illustrates a command execution method executed by the printing apparatus 200. The processing illustrated in FIG. 5 can be implemented by a computer of the printing apparatus 200 executing a program. In other words, the program causes the computer of the printing apparatus 200 to execute the processing illustrated in FIG. 5.

The printing apparatus 200 receives command information (step S202). Specifically, the command receiving section 230 receives the command information including a command designated by the terminal apparatus 100 as described above.

The printing apparatus 200 determines whether or not the command that is to be executed and is designated in the command information is the drive command (step S204). For example, the command receiving section 230 may determine whether or not the drive command is included in the command information. When the command to be executed is the drive command (YES in S204), the printing apparatus 200 displays the permission screen (step S212). Specifically, as described above, the permission display processing section 240 controls the display section 212 to cause the display section 212 to display the permission screen. Note that the terminal apparatus 100 may execute the determination corresponding to step S204 and transmit, to the printing apparatus 200, information regarding whether or not to display the permission screen as a result of the determination. In addition, the information processing apparatus 10 may execute the determination corresponding to step S204 and transmit, to the printing apparatus 200, the information regarding whether or not to display the permission screen as a result of the determination.

The printing apparatus 200 determines whether or not an operation for permission has been performed on the permission screen (step S214). Specifically, the permission display processing section 240 determines whether or not the operation for the permission on the permission screen has been accepted. When the operation for the permission is not performed on the permission screen (NO in S214), the printing apparatus 200 waits until the operation for the permission is performed on the permission screen. When the operation for the permission is not performed on the permission screen even when a predetermined time elapses after the permission screen is displayed, the printing apparatus 200 may perform processing for transmitting, to the terminal apparatus 100, a notification indicating that the operation for the permission is not performed on the permission screen.

When the operation for the permission is performed on the permission screen (YES in S214), the printing apparatus 200 executes the drive command (step S216). Specifically, as described above, the command executing section 250 executes the drive command and controls the first drive component designated by the drive command so as to drive the first drive component by the drive amount designated by the drive command.

On the other hand, when the command to be executed is not the drive command in the command information (NO in S204), the command to be executed is the information processing command. Therefore, the command executing section 250 executes the information processing command designated in the command information (step S220). In this case, the printing apparatus 200 does not cause the display section 212 to display the permission screen. This is not the case when the command information includes the permission screen display command to be described later, and the printing apparatus 200 causes the display section 212 to display the permission screen.

Then, the printing apparatus 200 transmits apparatus information corresponding to a result of executing the command (step S230). Specifically, as described above, the command executing section 250 performs processing for transmitting, to the terminal apparatus 100, the apparatus information corresponding to the result of executing the command. Furthermore, the information transmission processing section 260 performs processing for transmitting the log information to the terminal apparatus 100.

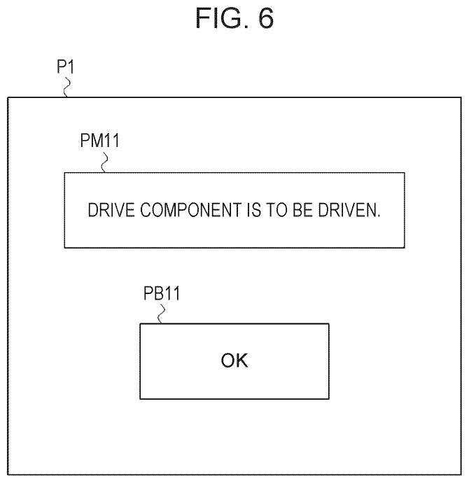

Next, a specific example of a screen displayed on the terminal apparatus 100 or the printing apparatus 200 will be described. FIG. 6 is a diagram illustrating an example of a permission screen P1 displayed on the printing apparatus 200 according to the first embodiment. The permission screen P1 is displayed on the display section 212, such as the operation panel of the printing apparatus 200, by the permission display processing section 240. The permission screen P1 displays a message PM11 indicating content for which permission is requested, and a permission button PB11 for accepting an operation for the permission. The message PM11 is a message for notifying the worker at the site that the drive component is to be driven. The message PM11 may indicate the name of the first drive component to be driven, such as the carriage motor. When the worker touches the permission button PB11, the operation for the permission is performed. In response to this, the command executing section 250 controls the first drive component to drive the first drive component.

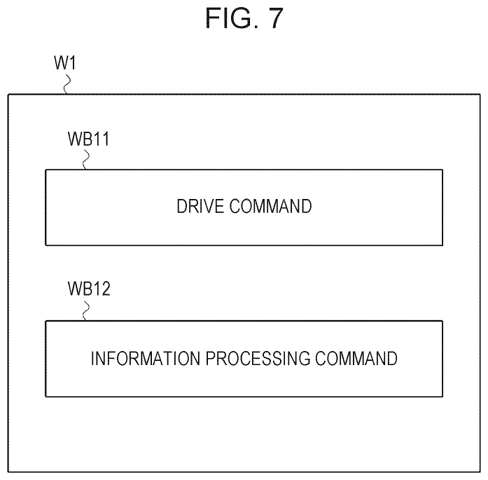

FIG. 7 is a diagram illustrating an instruction screen W1 displayed on the terminal apparatus 100 according to the first embodiment. The instruction screen W1 is displayed on the display section 112, such as the display of the terminal apparatus 100, by the instruction display processing section 120. The instruction screen W1 illustrated in FIG. 7 is the above-described command designation screen. The instruction screen W1 displays a drive command designation button WB11 for designating the drive command and an information processing command designation button WB12 for designating the information processing command. When the instructor clicks the drive command designation button WB11, the drive command is designated. When the information processing command designation button WB12 is clicked, the information processing command is designated. In the example illustrated in FIG. 7, the commands are designated by the GUI buttons, but the commands may be designated by check boxes or radio buttons on the instruction screen W1. Alternatively, the instruction screen W1 may display a text box or a text area, and the instructor may enter a command to be designated in the text box or the text area to designate the command. The same applies to other instruction screens described later.

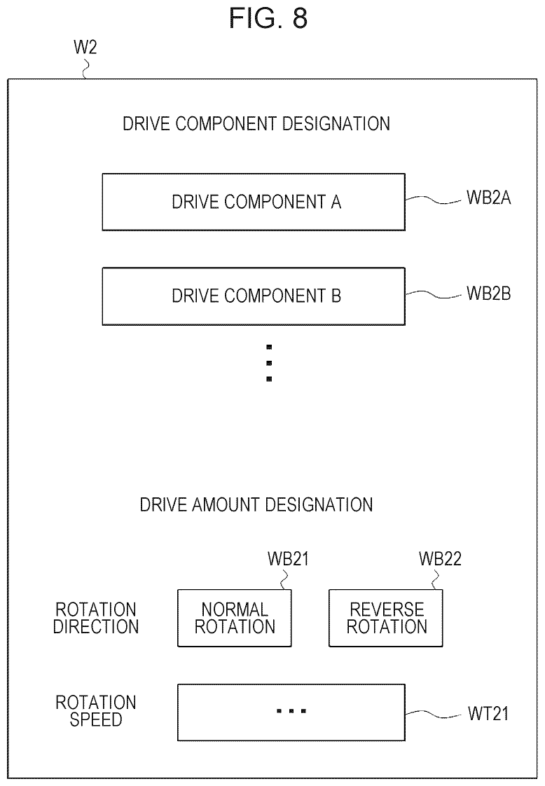

FIG. 8 is a diagram illustrating a drive designation screen W2 displayed on the terminal apparatus 100 according to the first embodiment. The drive designation screen W2 is displayed on the display section 112, such as the display of the terminal apparatus 100, by the instruction display processing section 120. The drive designation screen W2 displays drive component designation buttons WB2A and WB2B for designating drive components to be driven, drive direction designation buttons WB21 and WB22 for designating drive directions, and a rotation speed designation area WT21 for designating a rotation speed. The drive component designation buttons may be displayed by the number of drive components included in the printing apparatus 200. The drive component designation button WB2A is a button for designating a drive component A. When the instructor clicks the drive component designation button WB2A, the drive component A is designated as a drive component to be driven. The drive component designation button WB2B is a button for designating a drive component B. When the instructor clicks the drive component designation button WB2B, the drive component B is designated as a drive component to be driven. The drive direction designation button WB21 is a button for designating normal rotation of a designated drive component. When the instructor clicks the drive direction designation button WB21, the rotation direction of the designated drive component is designated as normal rotation. The drive direction designation button WB22 is a button for designating reverse rotation of the designated drive component. When the instructor clicks the drive direction designation button WB22, the rotation direction of the designated drive component is designated as reverse rotation. The rotation speed designation area WT21 is a text box for entering a rotation speed. When the instructor enters a numerical value in the rotation speed designation area WT21, the rotation speed of the designated drive component is designated as the numerical value. For example, when “3” is entered in the rotation speed designation area WT21, the drive component is designated to rotate three times.

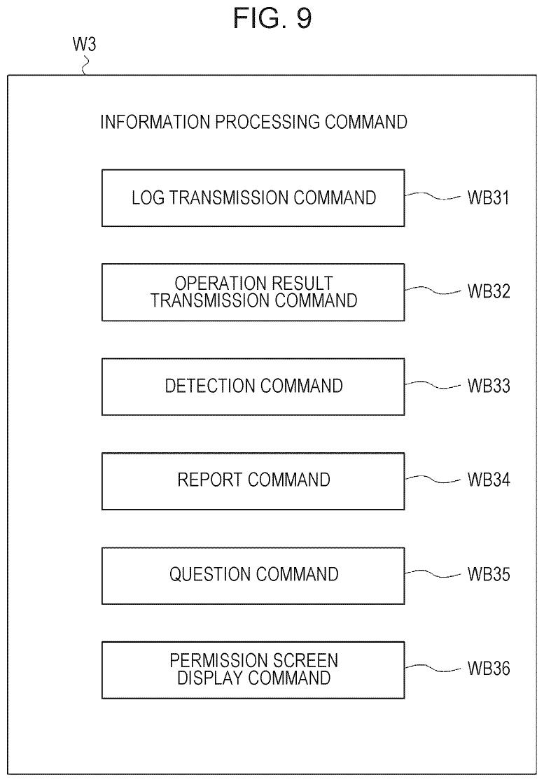

FIG. 9 is a diagram illustrating an instruction screen W3 displayed on the terminal apparatus 100 according to the first embodiment. The instruction screen W3 is displayed on the display section 112, such as the display of the terminal apparatus 100, by the instruction display processing section 120. The instruction screen W3 illustrated in FIG. 9 is the above-described command designation screen. The instruction screen W3 is a screen for designating which of a plurality of information processing commands is to be executed. The instruction screen W3 may be displayed when the information processing command designation button WB12 is clicked on the instruction screen W1 illustrated in FIG. 7. The instruction screen W3 displays a log transmission command designation button WB31, an operation result transmission command designation button WB32, a detection command designation button WB33, a report command designation button WB34, and a question command designation button WB35. The instruction screen W3 may display a permission screen display command designation button WB36.

The log transmission command designation button WB31 is a button for designating the log transmission command. When the instructor clicks the log transmission command designation button WB31, the log transmission command is designated as a command to be executed.

The operation result transmission command designation button WB32 is a button for designating the operation result transmission command. When the instructor clicks the operation result transmission command designation button WB32, the operation result transmission command is designated as a command to be executed.

The detection command designation button WB33 is a button for designating the detection command. When the instructor clicks the detection command designation button WB33, the detection command is designated as a command to be executed.

The report command designation button WB34 is a button for designating the report command. When the instructor clicks the report command designation button WB34, the report command is designated as a command to be executed.

The question command designation button WB35 is a button for designating the question command. When the instructor clicks the question command designation button WB35, the question command is designated as a command to be executed.

The permission screen display command designation button WB36 is a button for designating the permission screen display command. When the instructor clicks the permission screen display command designation button WB36, the permission screen display command is designated as a command to be executed. In this case, the permission screen P1 illustrated in FIG. 6 is displayed on the display section 212 such as the operation panel of the printing apparatus 200. When the instructor designates the permission screen display command in this manner, the printing apparatus 200 can also display the permission screen P1 on the display section 212 regardless of whether or not the command that is to be executed and is designated in the command information is the drive command, that is, regardless of the determination in step S204 described above.

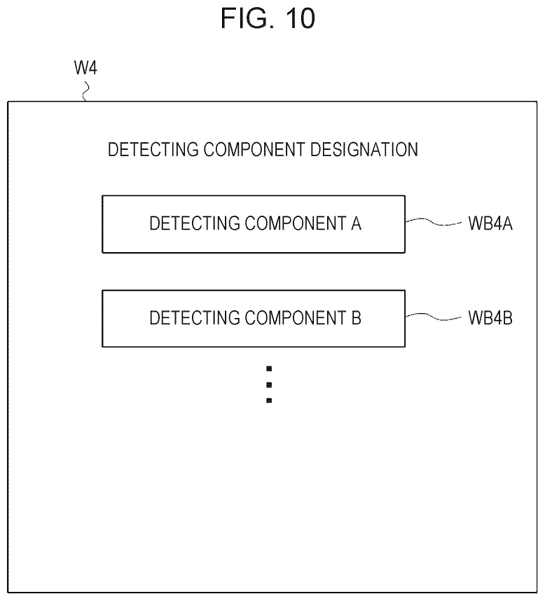

FIG. 10 is a diagram illustrating a detection designation screen W4 displayed on the terminal apparatus 100 according to the first embodiment. The detection designation screen W4 may be displayed when the detection command designation button WB33 is clicked on the instruction screen W3 illustrated in FIG. 9. The detection designation screen W4 is displayed on the display section 112, such as the display of the terminal apparatus 100, by the instruction display processing section 120. The detection designation screen W4 displays detecting component designation buttons WB4A and WB4B for designating detecting components to be caused to perform detection. The detecting component designation buttons may be displayed by the number of detecting components included in the printing apparatus 200. The detecting component designation button WB4A is a button for designating a detecting component A. When the instructor clicks the detecting component designation button WB4A, the detecting component A is designated as a detecting component to be caused to perform detection. The detecting component designation button WB4B is a button for designating a detecting component B. When the instructor clicks the detecting component designation button WB4B, the detecting component B is designated as a detecting component to be caused to perform detection.

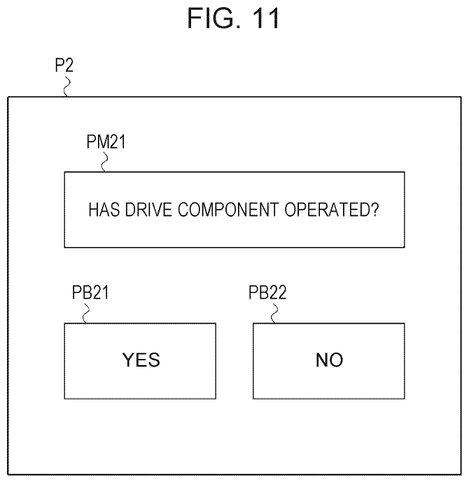

FIG. 11 is a diagram illustrating an example of a report screen P2 displayed on the printing apparatus 200 according to the first embodiment. The report screen P2 may be displayed when the report command designation button WB34 is clicked on the instruction screen W3 illustrated in FIG. 9. The report screen P2 is displayed on the display section 212, such as the operation panel of the printing apparatus 200, by the command executing section 250. The report screen P2 displays a message PM21 indicating content for which a report is requested, and report buttons PB21 and PB22 for accepting a report operation. The message PM21 is a message for causing the worker at the site to report whether or not the drive component has operated. The message PM21 may indicate the name of the first drive component to be driven, such as the carriage motor. The report button PB21 is a button for reporting that the drive component has operated. When the worker touches the report button PB21, an operation for reporting that the drive component has operated is performed. In response to this, the command executing section 250 performs processing for transmitting a report indicating that the first drive component has operated. The report button PB22 is a button for reporting that the drive component has not operated. When the worker touches the report button PB22, an operation for reporting that the drive component has not operated is performed. In response to this, the command executing section 250 performs processing for transmitting a report indicating that the first drive component has not operated.

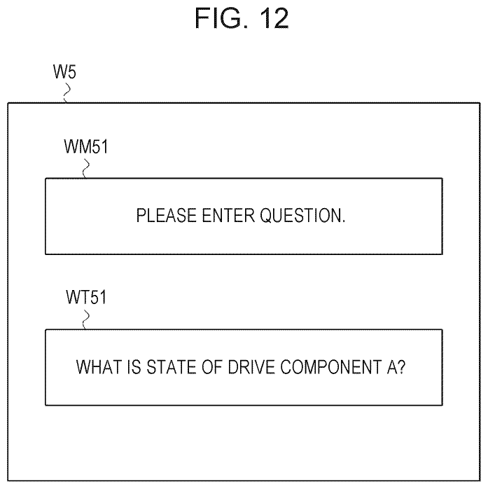

FIG. 12 is a diagram illustrating a question entry screen W5 displayed on the terminal apparatus 100 according to the first embodiment. The question entry screen W5 may be displayed when the question command designation button WB35 is clicked on the instruction screen W3 illustrated in FIG. 9. The question entry screen W5 is displayed on the display section 112, such as the display of the terminal apparatus 100, by the instruction display processing section 120. The question entry screen W5 displays a message WM51 for prompting a question and a text area WT51 for entering a question. The instructor enters a question as a character string in the text area WT51. Then, a question command indicating the content of the question entered in the text area WT51 is transmitted to the printing apparatus 200 by processing of the command transmission processing section 140.

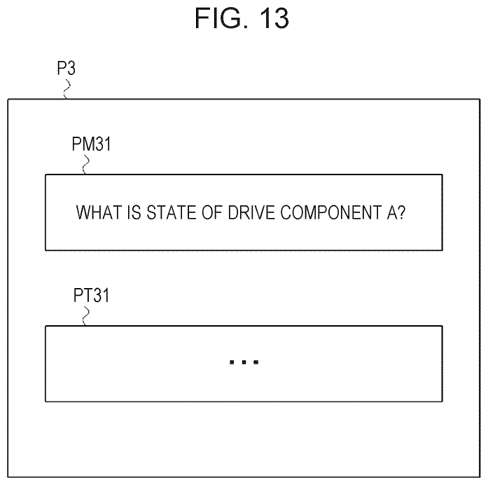

FIG. 13 is a diagram illustrating an example of a question screen P3 displayed on the printing apparatus 200 according to the first embodiment. The question screen P3 may be displayed when the question command designation button WB35 is clicked on the instruction screen W3 illustrated in FIG. 9. The question screen P3 is displayed on the display section 212, such as the operation panel of the printing apparatus 200, by the command executing section 250. The question screen P3 displays a message PM31 indicating the content of a question and a text area PT31 for entering an answer to the question. The content indicated in the message PM31 corresponds to the content entered in the text area WT51 of the question entry screen W5 illustrated in FIG. 12. The worker enters, as a character string, an answer to the question in the text area PT31. In response to this, the command executing section 250 performs processing for transmitting the answer to the question.

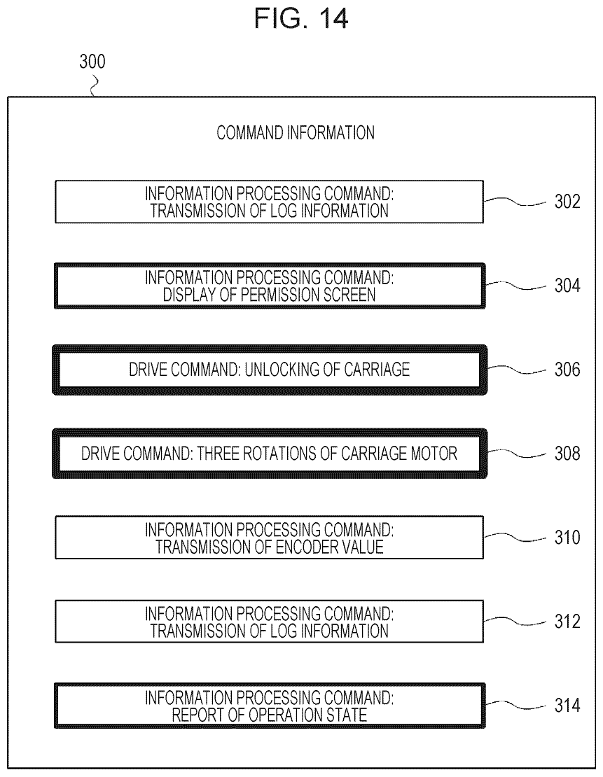

FIG. 14 is a diagram illustrating command information 300 according to the first embodiment. The command information 300 illustrated in FIG. 14 includes a plurality of commands. In the command information 300 illustrated in FIG. 14, the order in which the plurality of commands are executed is designated.

Specifically, the command information 300 includes an information processing command 302 to be executed first. The information processing command 302 is a log transmission command. Furthermore, the command information 300 includes an information processing command 304 to be executed second. The information processing command 304 is a permission screen display command. Furthermore, the command information 300 includes a drive command 306 to be executed third. The drive command 306 is a drive command for requesting unlocking of the carriage. Furthermore, the command information 300 includes a drive command 308 to be executed fourth. The drive command 308 is a drive command for requesting that the carriage motor rotates three times. Furthermore, the command information 300 includes an information processing command 310 to be executed fifth. The information processing command 310 is a detection command or an operation result transmission command for requesting transmission of an encoder value. Furthermore, the command information 300 includes an information processing command 312 to be executed sixth. The information processing command 312 is a log transmission command. Furthermore, the command information 300 includes an information processing command 314 to be executed seventh. The information processing command 314 is a report command for requesting a report of an operation state.

When the command information 300 is transmitted from the terminal apparatus 100 to the printing apparatus 200 via the information processing apparatus 10, first, the printing apparatus 200 executes the information processing command 302 and transmits the log information. Next, the printing apparatus 200 executes the information processing command 304 and displays the permission screen. When an operation for permission is performed on the permission screen, the printing apparatus 200 executes the drive command 306 to unlock the carriage, then executes the drive command 308, and rotates the carriage motor three times. In this way, when a plurality of drive commands are included in the command information 300, only the permission screen display command may be executed before the first drive command. Alternatively, when a plurality of drive commands are included in the command information 300, the permission screen display command may be executed before each of the plurality of drive commands. Note that even when the information processing command 304 for displaying the permission screen is not included in the command information 300, the printing apparatus 200 can cause the display section 212 to display or not to display the permission screen by executing the processing illustrated in the flowchart of FIG. 5, that is, the processing for determining whether or not the drive command is included in the command information.

Next, the printing apparatus 200 executes the information processing command 310 and transmits the encoder value. Next, the printing apparatus 200 executes the information processing command 312 and transmits the log information. Next, the printing apparatus 200 executes the information processing command 314 and displays the report screen. Then, when a report operation is performed on the report screen, the printing apparatus 200 transmits a report. As described above, the information processing command after the drive command in the order may be executed when the permission screen display command before the drive command is executed, the operation for the permission is performed, and the drive command is executed.

As described above, in the printing system 1 according to the first embodiment, the terminal apparatus 100 performs processing for transmitting, to the printing apparatus 200, command information including one or more commands for causing the printing apparatus 200 to execute a specific operation. Then, the printing apparatus 200 receives the command information, and executes processing for displaying the permission screen at least when the command information requests the driving of the specific first drive component. Then, the printing apparatus 200 executes the command for driving the first drive component in response to acceptance of the operation for the permission on the permission screen. With such a configuration, when the instructor performs remote control from the remote location in the maintenance processing of the printing apparatus 200, it is possible to prevent the drive component from being driven in a situation which is not expected by the worker at the site. Therefore, when the maintenance processing of the printing apparatus 200 is performed from the remote location, the instructor at the remote location can give an instruction in consideration of the site.

In addition, the terminal apparatus 100 according to the first embodiment may perform processing for displaying the instruction screen for accepting an operation of a user's instruction for generating command information. Then, the terminal apparatus 100 performs processing for transmitting, to the printing apparatus 200, the command information including a command designated by the operation using the instruction screen. Furthermore, the terminal apparatus 100 may perform processing for displaying the drive designation screen for accepting designation of the first drive component to be driven among the plurality of drive components. Then, the terminal apparatus 100 performs processing for transmitting, to the printing apparatus 200, the command information including a command for requesting the driving of the first drive component designated using the drive designation screen. In addition, the terminal apparatus 100 may perform processing for displaying the drive designation screen for accepting designation of a drive amount of the designated first drive component. Then, the terminal apparatus 100 performs processing for transmitting, to the printing apparatus 200, the command information including a command for requesting the driving of the first drive component by the drive amount designated using the drive designation screen. With such a configuration, the instructor at the remote location can easily designate a command to be transmitted to the printing apparatus 200.

In addition, in the printing system 1 according to the first embodiment, a command may include a drive command that requests the driving of the first drive component and an information processing command that requests information processing in the printing apparatus 200 and does not request the driving of the drive component. The printing apparatus 200 may display the permission screen when the drive command is to be executed, and may not display the permission screen when the information processing command is to be executed. Even when the information processing is performed in the printing apparatus 200 in a situation which is not expected by the worker at the site, the drive component is not driven, and thus the effect on the worker is small. Therefore, it is unlikely that there is a problem for the worker. Therefore, it is less necessary to obtain the permission of the worker at the site before the information processing is performed by the remote control in the printing apparatus 200. Therefore, with such a configuration, since excessive display of the permission screen is suppressed, it is possible to suppress prolongation of the time of the maintenance processing.

In the printing system 1 according to the first embodiment, a plurality of commands may be included in the command information. Then, when the drive command is included in the command information, the printing apparatus 200 performs processing for displaying the permission screen. Furthermore, in the command information, the order in which the plurality of commands are executed may be designated. Then, the printing apparatus 200 executes the information processing command, which is after the drive command in the order in the command information, after executing the drive command in response to the acceptance of the operation for the permission on the permission screen. The information processing command may include the permission screen display command for requesting the display of the permission screen. When the permission screen display command is executed, the printing apparatus 200 performs processing for displaying the permission screen. With such a configuration, the instructor can flexibly execute a command according to the status of the maintenance processing.

In the printing system 1 according to the first embodiment, the information processing command may include the report command for requesting display of the report screen for accepting an operation for reporting the operation state of the printing apparatus 200, and requesting transmission of a report. Then, the printing apparatus 200 executes the report command, performs processing for displaying the report screen, and performs processing for transmitting the report corresponding to an operation on the report screen. With such a configuration, the instructor can easily acquire the report of the operation state of the drive component from the worker at the site without depending on the content of the detection by the detecting component of the printing apparatus 200. Thus, the instructor can determine the content of the remote control to be performed next according to the report of the worker. Therefore, it is possible to efficiently perform the maintenance processing by the remote control.

In the printing system 1 according to the first embodiment, the information processing command may include the operation result transmission command for requesting information processing for transmitting the operation result of the first drive component. Then, the printing apparatus 200 executes the operation result transmission command and performs processing for transmitting the operation result. With such a configuration, it is possible to acquire the operation result of the drive component at a timing desired by the instructor without depending on communication from the worker at the site. Therefore, it is possible to efficiently perform the maintenance processing by the remote control.

Furthermore, in the printing system 1 according to the first embodiment, the information processing command may include a question command for displaying a question screen for accepting an answer to a question from the instructor who is the user of the terminal apparatus 100, and requesting transmission of the answer to the question. Then, the printing apparatus 200 executes the question command, performs processing for displaying the question screen, and performs processing for transmitting an answer corresponding to an operation on the question screen. With such a configuration, the worker at the site can communicate with the instructor without using a communication device. Therefore, it is possible to efficiently perform the maintenance processing by the remote control.

In addition, the terminal apparatus 100 according to the first embodiment may perform processing for displaying the detection designation screen for accepting designation of the first detecting component to be caused to perform detection among the plurality of detecting components of the printing apparatus 200. Then, the terminal apparatus 100 performs processing for transmitting, to the printing apparatus 200, command information including the command for requesting detection by the first detecting component designated using the detection designation screen. With such a configuration, the instructor can designate as appropriate a detecting component to be caused to execute detection. Therefore, it is possible to efficiently perform the maintenance processing by the remote control.

In addition, in the above-described embodiment, it is described that the maintenance processing is performed by the remote control, but a method in which a self-diagnosis function is included in the main body of the printing apparatus 200 and the maintenance processing is performed only by the worker at the site is also considered. On the other hand, as in the present embodiment, it is possible to try a procedure of new maintenance processing by performing communication between the instructor at the remote location and the worker at the site. In addition, by notifying the state of the printing apparatus 200 from the worker by using the above-described command information, it is possible to try a plurality of different procedures. Then, the printing apparatus 200 may be provided with a self-diagnosis function which is capable of, when a good procedure can be established, executing this procedure.

### Modifications

Note that the present invention is not limited to the above-described embodiment, and can be appropriately modified without departing from the spirit of the present disclosure. For example, the order of the steps in each of the flowcharts described above can be changed as appropriate. Furthermore, one or more of the steps in the flowcharts described above may be omitted.

Furthermore, the printing system 1 may not include the information processing apparatus 10. In this case, the terminal apparatus 100 is directly communicably coupled to the printing apparatus 200 via a network. In this case, the terminal apparatus 100 directly acquires the apparatus information from the printing apparatus 200 via the network. In this case, the terminal apparatus 100 generates the command information and directly transmits the command information to the printing apparatus 200 via the network.

In the above-described examples, each of the programs includes an instruction group (or software code) for causing a computer to perform one or more of the functions described in the embodiment when the program is read into the computer. Each of the programs may be stored in a non-transitory computer-readable medium or a tangible storage medium. By way of example, and not limitation, such computer-readable media or tangible storage media may include a random-access memory (RAM), a read-only memory (ROM), a flash memory, a solid-state drive (SSD) or other memory technology, a CD-ROM, a digital versatile disc (DVD), a Blu-ray (registered trademark) disc or other optical disc storage, a magnetic cassette, a magnetic tape, magnetic disk storage or another magnetic storage device. Each of the programs may be transmitted on a transitory computer-readable medium or a communication medium. By way of example, and not limitation, such transitory computer-readable media or communication media include electrical, optical, acoustical or other forms of propagated signals. Furthermore, each of the programs is included in a program product.

What is claimed is:

1. A printing system comprising:
a printing apparatus that includes one or more drive components and performs printing; and
a terminal apparatus communicably coupled to the printing apparatus via a network, wherein
the terminal apparatus includes
a command transmission processing section that performs processing for transmitting, to the printing apparatus, command information including one or more commands for causing the printing apparatus to execute a specific operation, and
the printing apparatus includes
a command receiving section that receives the command information,
a permission display processing section that performs processing for displaying a permission screen for accepting permission to drive a specific first drive component at least when the command information requests the driving of the first drive component, and
a command executing section that executes a command for driving the first drive component in response to acceptance of an operation for the permission on the permission screen.

2. The printing system according to claim 1, wherein
the terminal apparatus further includes an instruction display processing section that performs processing for displaying an instruction screen for accepting an operation of a user's instruction for generating the command information, and
the command transmission processing section performs processing for transmitting, to the printing apparatus, the command information including a command designated by the operation using the instruction screen.

3. The printing system according to claim 2, wherein
the one or more drive components included in the printing apparatus include a plurality of drive components,
the instruction display processing section executes processing for displaying a drive designation screen for accepting designation of the first drive component to be driven among the plurality of drive components, and
the command transmission processing section performs processing for transmitting, to the printing apparatus, the command information including a command for requesting the driving of the first drive component designated using the drive designation screen.

4. The printing system according to claim 3, wherein
the instruction display processing section executes processing for displaying the drive designation screen for accepting designation of a drive amount of the designated first drive component, and
the command transmission processing section performs processing for transmitting, to the printing apparatus, the command information including a command for requesting the driving of the first drive component by the drive amount designated using the drive designation screen.

5. The printing system according to claim 1, wherein
the command includes
a drive command for requesting the driving of the first drive component, and
an information processing command that requests information processing in the printing apparatus and does not request driving of the drive component, and
the permission display processing section displays the permission screen when the drive command is to be executed, and does not display the permission screen when the information processing command is to be executed.

6. The printing system according to claim 5, wherein
the one or more commands included in the command information include a plurality of commands, and
the permission display processing section performs the processing for displaying the permission screen when the drive command is included in the command information.

7. The printing system according to claim 6, wherein
an order in which the plurality of commands are executed is designated in the command information, and
when the information processing command after the drive command in the order in the command information is present, the command executing section executes the information processing command after executing the drive command in response to the acceptance of the operation for the permission on the permission screen.

8. The printing system according to claim 5, wherein
the information processing command includes a permission screen display command for requesting the display of the permission screen, and
the permission display processing section performs the processing for displaying the permission screen when the command executing section executes the permission screen display command.

9. The printing system according to claim 5, wherein
the information processing command includes a report command for requesting display of a report screen for accepting an operation for reporting an operation state of the printing apparatus, and requesting transmission of the report, and
the command executing section
executes the report command and performs processing for displaying the report screen, and
performs processing for transmitting a report corresponding to an operation on the report screen.

10. The printing system according to claim 5, wherein
the information processing command includes an operation result transmission command for requesting information processing for transmitting an operation result of the first drive component, and
the command executing section executes the operation result transmission command and performs processing for transmitting the operation result.

11. The printing system according to claim 5, wherein
the information processing command includes a question command for displaying a question screen for accepting an answer to a question from a user of the terminal apparatus, and requesting transmission of the answer to the question, and
the command executing section
executes the question command and performs processing for displaying the question screen, and
performs processing for transmitting an answer corresponding to an operation on the question screen.

12. The printing system according to claim 2, wherein
the printing apparatus includes a plurality of detecting components that detect a state of the printing apparatus,
the instruction display processing section performs processing for displaying a detection designation screen for accepting designation of a first detecting component to be caused to perform detection among the plurality of detecting components, and
the command transmission processing section performs processing for transmitting, to the printing apparatus, the command information including a command for requesting the detection by the first detecting component designated using the detection designation screen.

13. A printing apparatus that includes one or more drive components and performs printing, the printing apparatus comprising;
a command receiving section that receives command information including one or more commands for causing the printing apparatus to execute a specific operation;
a permission display processing section that performs processing for displaying a permission screen for accepting permission to drive a specific first drive component at least when the command information requests the driving of the first drive component; and
a command executing section that executes a command for driving the first drive component in response to acceptance of an operation for the permission on the permission screen.

14. A non-transitory computer-readable medium storing a program for causing a computer of a printing apparatus which includes one or more drive components and performs printing to execute:
processing for receiving command information including one or more commands for causing the printing apparatus to execute a specific operation;
processing for displaying a permission screen for accepting permission to drive a specific first drive component at least when the command information requests the driving of the first drive component; and
processing for executing a command for driving the first drive component in response to acceptance of an operation for the permission on the permission screen.
